(19) United States
(12) Patent Application Publication
(10) Pub. No.: US 2011/0154180 A1
(43) Pub. Date: Jun. 23, 2011

(54) USER-SPECIFIC DIGITAL DOCUMENT ANNOTATIONS FOR COLLABORATIVE REVIEW PROCESS

(75) Inventors: Eugene Evanitsky, Pittsford, NY (US); Yevgeniy Shustef, Macedon, NY (US); Wilma Wandersleben Chlebove, Honeoye Falls, NY (US)

(73) Assignee: Xerox Corporation

(21) Appl. No.: 12/640,172

(22) Filed: Dec. 17, 2009

(51) Int. Cl. G06F 17/00; G06F 3/048

(52) U.S. Cl. 715/233; 715/230; 715/764

(57) ABSTRACT

A reviewer opens or imports a document into a document viewer. The reviewer can then create various annotations to the document. The reviewer then has the option of assigning each annotation to a specific recipient or group of recipients. The document viewer can be implemented as a centralized application where recipients to whom annotations have been assigned are notified that a document is available for viewing. Upon receipt of this notification, recipients can log on to the document viewer to view the document containing the annotations specific to each recipient. Alternatively, the document viewer can be implemented as a stand-alone application where recipients to whom annotations have been assigned are sent the document showing only those annotations intended for each specific recipient.

### TECHNICAL FIELD

Embodiments are generally related to the field of computers and similar technologies and, in particular, to software utilized in this field. Embodiments are also related to digital document annotation methods and systems. Embodiments are further related to the creation of user specific annotations and to digital document sharing.

### BACKGROUND OF THE INVENTION

Document annotation is a powerful tool in information sharing as it provides a means of emphasizing particular portions of a document, aiding in the summarization of longer or highly complex text passages of a document, and demonstrating connections among different portions of a document. Conventionally, readers of a paper document might highlight a passage of the document, make notes in the margins of the document, or circle, underline or place an asterisk next to selected passages of the document. These types of markings are typically added to a document that has already been completed by a given author. The reader of the document may then subsequently make markings on the document for his own personal use, or for the benefit of others.

Increasingly, document review and information sharing is performed electronically, by email or other such exchanging of digital documents (e.g. those stored in a memory of a computer system and displayed on a multi-function device screen for viewing). Documents are distributed to reviewer(s), who in turn may make comments on hard copies (print-outs) or using digital annotations in the case of soft copies (digital documents). Document annotation performed on digital documents has seen increased acceptance in the recent past. For example, some word processor software allows users to highlight and underline selected text and to “attach” comments at selected locations within a document. The documents are then sent back to the author(s) who can act based on the comments.

A drawback to the current process and technology is that all annotations are made available and visible to all users. In the case of short documents, it may not be significantly inconvenient since it is fairly easy to sort through all the comments and find those that are relevant. In the case of a large document and lengthy review process, this process can be terribly inconvenient for document collaborators and becomes an even bigger burden as the number of collaborators grows. Similarly, not all annotations or portions of a document may be appropriate to certain collaborators, such as annotations containing sensitive financial information or the like. Another drawback to current technology available for document annotation is that it is generally limited to text documents. Often, sharing information with colleagues and collaborators includes sharing items in a myriad of formats including: photos, scanned images, video, and other forms of digital documentation.

Therefore, the Applicants believe a need exists for a system and method of digital annotation to allow for recipient specific annotations that can be utilized with a wide variety of file formats.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is one aspect of the present invention to provide for a document viewer in which a reviewer can create recipient specific annotations to a document.

It is another aspect of the present invention to provide a document viewer in which a wide variety of file formats can be annotated.

It is a further aspect of the present invention to provide a system in which a digital document containing recipient specific annotations can be viewed by those recipients to which the annotations have been assigned.

It is yet another aspect of the present invention to provide a system in which a digital document containing recipient specific annotations can be sent electronically to those recipients to which the annotations have been assigned.

The aforementioned aspects and other objectives and advantages can be achieved as described herein. A reviewer opens or imports a document into a document viewer. The reviewer can then create various annotations to the document. The reviewer then has the option of assigning each annotation to a specific recipient or group of recipients. The document viewer can be implemented as a centralized application where recipients to whom annotations have been assigned are notified that a document is available for viewing. Upon receipt of this notification, recipients can log on to the document viewer to view the document containing the annotations specific to each recipient. Alternatively, the document viewer can be implemented as a stand-alone application where recipients to whom annotations have been assigned are sent the document showing only those annotations intended for each specific recipient. Embodiments can be implemented in situations where a number of authors are collaborating on a single document as well as being implemented as a collaboration tool for ad hoc processes.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary system embodied by multiple computing devices, a network, and a database, through which an embodiment can be implemented;

FIG. 2 illustrates a document viewer wherein a digital document is annotated with recipient specific annotations and example documents that may be viewed by specific recipients containing only those annotations which have been assigned to each recipient, in accordance with the disclosed embodiments; and

FIG. 3 illustrates a detailed flow chart of operations illustrating logical operational steps of a method for creating recipient specific annotations using the document viewer system, in accordance with the disclosed embodiments.

### DETAILED DESCRIPTION

It is to be understood by persons of ordinary skill in the art that the following descriptions are provided for purposes of illustration and not for limitation. An artisan understands there are many variations that lie within the spirit of the invention and the scope of the appended claims. Unnecessary detail of known functions and operations may be omitted from the current description so as not to obscure the present invention.

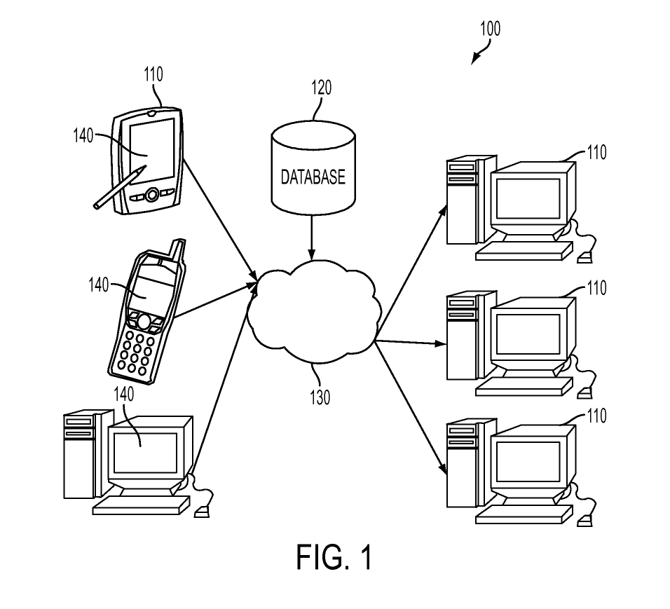

FIG. 1 illustrates an exemplary system 100 on which the following system and method may be implemented. It is to be understood that certain aspects of the system 100 would operate in accordance with pre-programmed instructions used to operate a local or networked computing device 110 to carry out such features, perhaps on a plurality of interconnected computing devices 110 at a time. Such a system 100 might include a commercially available computing device 110, such as personal computer or cellular phone with appropriate graphics rendering capability that can also be associated with a networked database 120 or similar memory device wherein the system 100 is accessible, perhaps via an Internet/intranet network 130 for exchange of digital information. Computing device 110 includes a graphical user interface (GUI) 140. GUI 140 can be touch responsive such that a user can utilize their finger or a stylus to directly select and manipulate items displayed on the GUI 140. Where the GUI 140 is not touch responsive, a mouse or similar pointing device can be utilized by a user to interact with the GUI. Note that in FIGS. 1-3, identical or similar parts or elements are indicated by identical reference numerals.

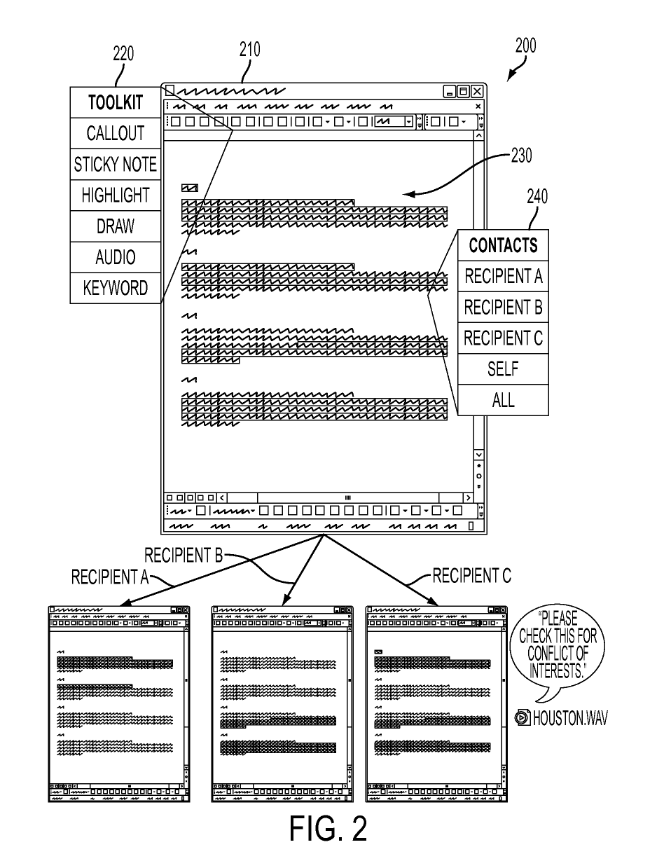

FIG. 2 illustrates an annotation system 200 for creating and distributing recipient-specific annotations made by a reviewer to a digital document 230 according to one embodiment. Annotation system 200 includes a document viewer 210 in which a user can open a digital document 230 to create user specific annotations. A wide variety of file types can be supported by the document viewer including: text, photographs, video, scanned images, web pages, etc. An Optical-Character Recognition (OCR) module, or similar technology, can also be utilized by document viewer 210 to convert writing or print, which is not in a text format, such as a photo or scan of a document, to a usable text format.

Note that as utilized herein, the term “module” refers generally to (but are not limited to) routines, subroutines, software applications, programs, objects, components, data structures, and so forth, which perform particular tasks or implement particular abstract data types and/or instructions. Those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

Document viewer 210 includes an annotation toolkit 220 containing a variety of annotation methods to be selected by the user. For example, the annotation toolkit 220 can contain options for inserting/creating callouts, sticky notes, highlighting, drawing, and audio type annotations. Annotation toolkit 220 can also include an option for opaque highlighting to be used for redaction of portions of the document that may not be appropriate to certain recipients (e.g. financial data or other sensitive information). A reviewer selects text or other data in a document 230 by either touching the GUI 140 of the device 110 or utilizing a pointing device. Reviewer can also make markings/drawings on the document 230 or insert sticky notes, callouts, and audio annotations using the same method. Once an annotation has been created, it is then assigned to a specific recipient or group of recipients in a contacts list 240 by the reviewer. Additionally, annotation toolkit 220 can allow the reviewer to insert specialized annotations in order to associate keywords or other document information within the document 230 such that it can be searched for later. Such document information may include an article title, author, date of publication, etc.

Annotations created within the document viewer 210 can be saved as metadata associated with the original document 230 such that the original document 230 remains unaltered. This metadata can be stored on a networked database 120 or similar memory device associated with the system.

In an embodiment, the document viewer 210 can be implemented as a centralized application wherein recipients who have been assigned user specific annotations within a document 230 are notified by email, or other means, that a document 230 is available for viewing. The recipient can then log in to the document viewer 210 to review the digital document 230 containing the user-specific annotations assigned to that particular recipient. Another embodiment provides the document viewer 210 as a stand-alone application from which a copy of the document 230 is sent to each recipient such that only the document 230 as specifically annotated can be viewed by the recipient. In other words, a recipient will only see the document 230 containing annotations specific to them and not the original document. This is particularly pertinent where redaction has been performed on the document.

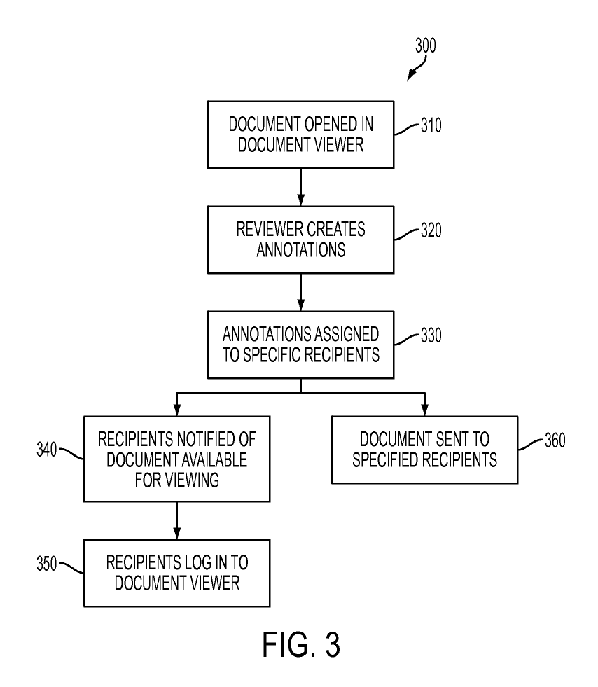

FIG. 3 illustrates a detailed flow chart of operations illustrating logical operational steps of a method 300 for creating and sharing user specific annotations associated with a digital document 230. As illustrated in block 310, a document is opened or imported into the document viewer 210. A reviewer then creates various annotations to the document, as shown in block 320. Reviewer then has the option of assigning each annotation to a specific recipient or group of recipients, as shown in block 330. Where the document viewer 210 is implemented as a centralized application, recipients to whom annotations have been assigned are notified that a document 230 is available for viewing, as shown in block 340. Upon receipt of this notification, recipients can log on to the document viewer to view the document containing the annotations specific to each recipient, as shown in block 350. Alternatively, where document viewer 210 is implemented as a stand-alone application, recipients to whom annotations have been assigned are sent the document 230 showing only those annotations intended for each specific recipient, as shown in block 360.

It can be appreciated that the method 300 may be implemented in the context of computer-implementable instructions stored in a computer memory and retrieved and then processed by, for example, a processor or other appropriate data-processing device and/or system. It can be appreciated that the description herein is presented with respect to particular embodiments of the present invention, which may be embodied in the context of a data-processing system. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

Based on the foregoing, it can be appreciated that embodiments are disclosed, including a system for creating user specific annotations to a digital document. Such a system generally includes a computing device having a graphical user interface operably connected to a network, a document viewer implemented by the computing device, wherein the document viewer comprises an annotation toolkit configured to allow a reviewer to create annotations associated with the digital document, wherein the annotation toolkit allows the reviewer to assign each of the annotations to at least one specific recipient, and a database connected to the network wherein the annotations are stored as metadata associated with the digital document for viewing only by the specific recipient to whom at least one of the annotations is assigned.

In some embodiments of such a system, the document viewer can be implemented as a standalone application. In other embodiments of such a system, the digital document with the annotations can be distributed to each specific recipient to whom at least one of the annotations is assigned. In still other embodiments of such a system, the document viewer can be implemented as a centralized application. In another embodiment of such a system, each of the specific recipient(s) can be automatically notified that the digital document and the annotations associated with the digital document are available for viewing on such a centralized application. Additionally, the specific recipient can log into the centralized application to view the digital document and annotations associated with the digital document that have been assigned to the specific recipient. In some embodiments, the document viewer can include an Optical-Character Recognition module. In other embodiments of such a system, the annotations can include, but are not limited to, annotations such as, for example, a callout, a sticky note, a highlighted annotation, a drawing, and an audio type annotation. Additionally, in some embodiments, the annotation toolkit can be configured to permit a reviewer to insert specialized annotations containing keywords and document information. In other embodiments of such a system, the disclosed graphical user interface can be configured as a touch responsive GUI.

It can be further appreciated, based on the foregoing, that in other embodiments, a method is disclosed for creating user specific annotations. Such a method generally includes the steps of opening a digital document in a document viewer displayed on a graphical user interface, the document viewer comprising an annotation toolkit; creating a plurality of annotations associated with the digital document utilizing the annotation toolkit; assigning each of the annotations to one or more specific recipients to create one or more recipient assignments, wherein the annotations and the recipient assignment(s) are stored as metadata to the digital document; distributing the digital document with the annotations and the recipient assignments to the specific recipient(s); and allowing the specific recipient(s) to view only those the annotations assigned to the specific recipient(s).

In other embodiments of such a method, the annotations can include, for example, callouts, sticky notes, highlighting, drawing, and audio type annotations. In other embodiments of such a method, the annotation toolkit can be configured to allow a reviewer to insert specialized annotations containing keywords and document information. In still other embodiments of such a method, the document viewer can be provided by an Optical-Character Recognition module. In still further embodiments of such a method, the graphical user interface can be implemented as a touch responsive GUI.

It can be additionally appreciated based on the foregoing that other embodiments include a computer-usable medium for creating user specific annotations. In such an embodiment, the computer-usable medium generally embodies computer program code, and the computer program code includes computer executable instructions configured for opening a digital document in a document viewer displayed on a graphical user interface, the document viewer comprising an annotation toolkit; creating a plurality of annotations associated with the digital document; assigning each of the annotations to one or more specific recipients to create one or more recipient assignments, wherein the annotations and the recipient assignment(s) are stored as metadata to the digital document; notifying the specific recipient(s) that the document and the annotations are viewable in the document viewer; and allowing the specific recipient(s) to log into the document viewer to view only those the annotations assigned to the specific recipient(s).

In other embodiments of such a computer-usable medium, the annotations can include, but are not limited to, for example, callouts, sticky notes, highlighting, drawing, and audio type annotations. Additionally, in varying embodiments of such a computer-usable medium, the annotation toolkit can be configured to allow a reviewer to insert specialized annotations containing keywords and document information. Additionally, the document viewer further can be provided by, for example, an Optical-Character Recognition module. In still other embodiments of such a computer-usable medium, the document viewer can be displayable via a graphical user interface that is touch responsive.

While the present invention has been particularly shown and described with reference to a preferred embodiment, it will be understood by those skilled in the art that various changes in form and detail may be made therein without departing from the spirit and scope of the invention. It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for creating user specific annotations to a digital document comprising:
a computing device having a graphical user interface operably connected to a network;
a document viewer implemented by said computing device, wherein said document viewer comprises an annotation toolkit configured to allow a reviewer to create a plurality of annotations associated with said digital document, wherein said annotation toolkit allows said reviewer to assign each of said plurality of annotations to at least one specific recipient; and
a database connected to said network wherein said plurality of annotations are stored as metadata associated with said digital document for viewing only by said specific recipient to whom at least one of said plurality of annotations is assigned.

2. The system of claim 1 wherein said document viewer comprises a standalone application.

3. The system of claim 2 wherein said digital document with said plurality of annotations is distributed to each specific recipient to whom at least one of said plurality of annotations is assigned.

4. The system of claim 1 wherein said document viewer is implemented as a centralized application.

5. They system of claim 4 wherein each of said at least one specific recipient is notified that said digital document and said plurality of annotations associated with said digital document are available for viewing on said centralized application.

6. The system of claim 5 wherein said specific recipient logs in to said centralized application to view said digital document and said plurality of annotations associated with said digital document that have been assigned to said specific recipient.

7. The system of claim 1 wherein said document viewer further comprises an Optical-Character Recognition module.

8. The system of claim 1 wherein said plurality of annotations includes at least one of the following types of annotations: a callout, a sticky note, a highlighted annotation, a drawing, and an audio type annotation.

9. The system of claim 1 wherein said annotation toolkit permits a reviewer to insert specialized annotations containing keywords and document information.

10. The system of claim 1 wherein said graphical user interface is touch responsive.

11. A method for creating user specific annotations comprising:
opening a digital document in a document viewer displayed on a graphical user interface, said document viewer comprising an annotation toolkit;
creating a plurality of annotations associated with said digital document utilizing said annotation toolkit;
assigning each of said plurality of annotations to at least one specific recipient to create at least one recipient assignment, wherein said plurality of annotations and said at least one recipient assignment are stored as metadata to said digital document;
distributing said digital document with said plurality of annotations and said recipient assignments to said at least one specific recipient; and
allowing said at least one specific recipient to view only those said plurality of annotations assigned to said at least one specific recipient.

12. The method of claim 10 wherein said plurality of annotations includes at least one of callouts, sticky notes, highlighting, drawing, and audio type annotations.

13. The method of claim 10 wherein said annotation toolkit is configured to allow a reviewer to insert specialized annotations containing keywords and document information.

14. The method of claim 10 wherein said document viewer further comprises an Optical-Character Recognition module.

15. The method of claim 10 wherein said graphical user interface is touch responsive.

16. A computer-usable medium for creating user specific annotations, said computer-usable medium embodying computer program code, said computer program code comprising computer executable instructions configured for:
opening a digital document in a document viewer displayed on a graphical user interface, said document viewer comprising an annotation toolkit;
creating a plurality of annotations associated with said digital document;
assigning each of said plurality of annotations to at least one specific recipient to create at least one recipient assignment wherein said plurality of annotations and said at least one recipient assignment are stored as metadata to said digital document;
notifying said at least one specific recipient that said document and said plurality of annotations is viewable in said document viewer; and
allowing said at least one specific recipient to log in to said document viewer to view only those said plurality of annotations assigned to said at least one specific recipient.

17. The computer-usable medium of claim 16 wherein said plurality of annotations includes at least one of callouts, sticky notes, highlighting, drawing, and audio type annotations.

18. The computer-usable medium of claim 16 wherein said annotation toolkit is configured to allow a reviewer to insert specialized annotations containing keywords and document information.

19. The computer-usable medium of claim 16 wherein said document viewer further comprises an Optical-Character Recognition module.

20. The computer-usable medium of claim 16 wherein said document viewer is displayable via a graphical user interface that is touch responsive.
